(19) United States
(12) Patent Application Publication
(10) Pub. No.: US 2007/0212030 A1
(43) Pub. Date: Sep. 13, 2007

(54) Video playback apparatus

(75) Inventors: Tatsuo Koga, Daito City (JP); Yuji Yamamoto, Yawata City (JP); Ryosuke Ohtsuki, Osaka City (JP); Satoru Matsumoto, Izumi City (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/710,978

(22) Filed: Feb. 27, 2007

(30) Foreign Application Priority Data
Feb. 28, 2006 (JP) JP2006-53315
Mar. 20, 2006 (JP) JP2006-077839

(51) Int. Cl. H04N 7/00; H04N 5/91

(52) U.S. Cl. 386/96

(57) ABSTRACT

A silent detector detects a silent segment based on output of an audio signal of contents. A determination unit determines a segment, in which the time length of each silent segment is essentially a multiplication of the predetermined time, as a first content segment regarding continuous plural silent segments that are detected in the silent detector, to determine a segment in which the time length of each silent segment is not essentially a multiplication of the predetermined time, as a second content segment, and to extract a silent segment between the first content segment and the second content segment as a changing segment. A playback controller sets a playback position of contents to the position before a predetermined time from the changing segment when a first action instruction is received.

### CROSS REFERENCE TO RELATED APPLICATIONS

This application claims priority based on 35 USC 119 from prior Japanese Patent Application No. P2006-53315, filed on Feb. 28, 2006 and also from Japanese Patent Application No. P2006-077839 filed on Mar. 20, 2006, both entire contents of which are incorporated herein by reference.

### BACKGROUND OF THE INVENTION

1. Field of the Invention

The invention relates to a video playback apparatus that skips specific content in playback, such as the audio content of commercials and other portions.

2. Description of Related Art

The technology of skipping commercials during playback of video and audio that includes commercials (thereinafter, CM) has been proposed in a conventional manner. For example, CM detection can analyze the output power of an audio signal and detects a portion as a silent segment, in which output power strength is below a certain threshold. When the time length between the silent segments is equal to a CM time (for example, fifteen seconds or thirty seconds, etc.), the contents there between are deemed a CM. Via such CM detection, an action that skips around a CM, to playback of a main program without the CM, is referred to as a CM skip.

A CM detection method that determines a silent segment as above, based on fifteen seconds of silent segment in the main program, deems this portion a CM. In addition, a silent segment may exist for several seconds as a boundary between a main program and a CM. This segment is deemed a start time or an end time of a silent segment, either when a continuous sound becomes silence or when silence becomes a continuous sound, or when the time in between those times is utilized. In this case, the duration of the silent segment is not a CM time, and the duration cannot be detected as a CM.

Such false detections prevent adequate performance of a CM skip action when a transition occurs from a CM to the main program.

Japanese Patent Laid-Open No. 2005-182869 teaches a skip operation divided into two stages. This discloses a method wherein an image (an upcoming image) of a skip destination is replayed only for one second with the first skip button, and an actual skip is performed with the second skip operation. According to this method, a user recognizes a failure of a skip operation by viewing an upcoming image, and is given an opportunity to push a skip button once again. Therefore, a skip can appropriately be performed.

However, in the above method, when a skip action is actualized, a user is deemed to operate a skip action while confirming an upcoming image, which is not always simple and easy for a user.

### SUMMARY OF THE INVENTION

An aspect of the invention provides a video playback apparatus that enables a skip action to be performed appropriately for specific contents, and especially includes CM, etc. by a user's simple operation.

An aspect of the invention provides a video payback apparatus that includes a silent detector configured to detect a silent segment based on output of an audio signal of contents, a determination unit configured to determine a segment, in which the time length of each silent segment is essentially a multiplication of the predetermined time, as a first content segment regarding continuous plural silent segments that are detected in the silent detector, configured to determine a segment in which the time length of each silent segment is not essentially a multiplication of the predetermined time, as a second content segment, and configured to extract a silent segment between the first content segment and the second content segment as a changing segment, and a playback controller configured to set a playback position of contents to the position before a predetermined time from the changing segment when a first action instruction is received.

### BRIEF DESCRIPTION OF THE DRAWINGS

FIG. 1 is a block diagram showing configuration of a video playback apparatus in an embodiment.

FIG. 2 is a diagram showing an example of configuration of contents.

FIG. 3 is a flowchart showing a recording process in an embodiment.

FIG. 4 is a diagram explaining a CM detection in an embodiment.

FIG. 5 is a diagram showing an example of silent segment information in an embodiment.

FIG. 6 is a flowchart showing a CM detection process in an embodiment.

FIG. 7 is a flowchart showing a CM detection process in an embodiment.

FIG. 8 is a flowchart showing a CM detection process in an embodiment.

FIG. 9 is a diagram explaining a skip action in an embodiment.

FIG. 10 is a diagram explaining a skip action in an embodiment.

FIG. 11 is a diagram explaining a skip action in an embodiment.

FIG. 12 is a flowchart showing a skip action in an embodiment.

### DETAILED DESCRIPTION OF EMBODIMENTS

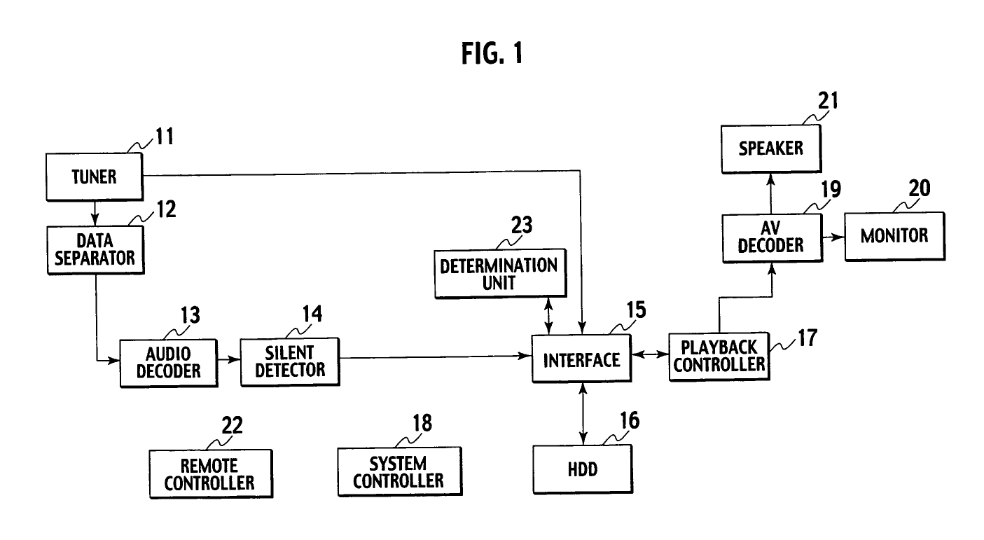

An embodiment of the invention is described with reference to the accompanying drawings. FIG. 1 is a diagram that shows the configuration of a video playback apparatus according to an embodiment. As shown in the figure, the video playback apparatus primarily consists of tuner 11, data separator 12, audio decoder 13, silent detector 14, determination unit 23, interface 15, storage device 16, playback controller 17, system controller 18, AV decoder 19, monitor 20, speaker 21, and remote controller 22.

Tuner 11 receives and detects an audio/video broadcasting signal to demodulate the signal to an encoded audio/video signal such as in a MPEG2-TS (Moving Picture Experts Group 2 Transport Stream) format. Data separator 12 separates the encoded audio/video signal such as a MPEG2-TS formatted signal, which is sent from tuner 11, into encoded audio and video signals. Audio decoder 13 converts the encoded audio signal, which is separated at data separator 12 into an audio signal. Silent detector 14 and determination unit 23 detect the contents of the CM.

More specifically, silent detector 14 detects silence based on the power value of an audio signal, which audio decoder 13 converts. In addition, start time Tn and end time Ty are recorded into storage device 16, as silent segment information about a detected silent segment. This start time and end time of the silent segment may correspond to time at which the main program starts. Determination unit 23 performs a CM detection by employing silent segment information, and this is recorded in above storage device 16.

In an embodiment, a first predetermined time T1 in the CM detection process as described later, is a multiplication (thirty seconds, sixty seconds, ninety seconds etc.) of 15 seconds, which matches present known commercial time periods. This is to determine whether a lag time between a start time and an end time of the silent segment is a CM time. A second predetermined time T2, which is utilized to determine the length of the silent segment between CMs, is approximately one second. A CM time includes a silent segment. Interface 15 is an interface that records an encoded audio/video signal into storage device 16, also receives an encoded audio/video signal from storage device 16, and records silent segment information obtained in silent detector 14 into storage device 16. Storage device 16 records an encoded audio/video signal.

In addition, a HDD (Hard Disk Drive) is shown in FIG. 1 as storage device 16; however, the device is not limited to this example. And, an interface to write and read to the HDD is shown in the figure as interface 15. The device is not limited to this example however.

Playback controller 17 performs playback control based on silent segment information stored in an HDD. Specified recorded parts, which are read from storage device 16, are replayed with AV decoder 19, and video, audio are respectively replayed in Monitor 20, Speaker 21 through AV decoder 19.

At the time of a CM skip action, a skip destination is determined based on silent segment information.

In an additional embodiment, a CM skip action as described below, such as a skip to a start time position of a silent segment, which is just before CM is changed to the main program, is performed. However, in the case when a skip to this desired position is not successful, more specifically, when a skip destination is during CM or during the main program, the time range to perform a skip action is set in order to get close to the desired position by a further small skip width. This time range may be set for twenty seconds as a third predetermined time T3.

System controller 18 controls components of the video record playback apparatus in an organized manner. AV decoder 19 obtains an encoded audio/video signal such as in a MPEG2-TS format recorded in storage device 16, and converts the signal into audio and video signals. Monitor 20 relays the video signal output for playback. Speaker 21 relays the audio signal output for playback. Remote controller 22 is an interface with a user, which conveys user's instructions to system controller 18. And, a user can directly convey to system controller as well.

In addition, the above data separator 12, audio decoder 13, silent detector 14, determination unit 23, playback controller 17, system controller 18, and AV decoder 19 can be realized within a computer system that may be characterized by a CPU (Central Processing Unit), memory and LSI (Large Scale Integration). This implementation comprises: preparing software to materialize the above each unit, loading the software onto memory, and executing the CPU. Functional blocks materialized within the collaboration above are shown in FIG. 1. Thus, several alternatives to materialize the functional blocks with hardware, software, or the collaboration of both can be realized.

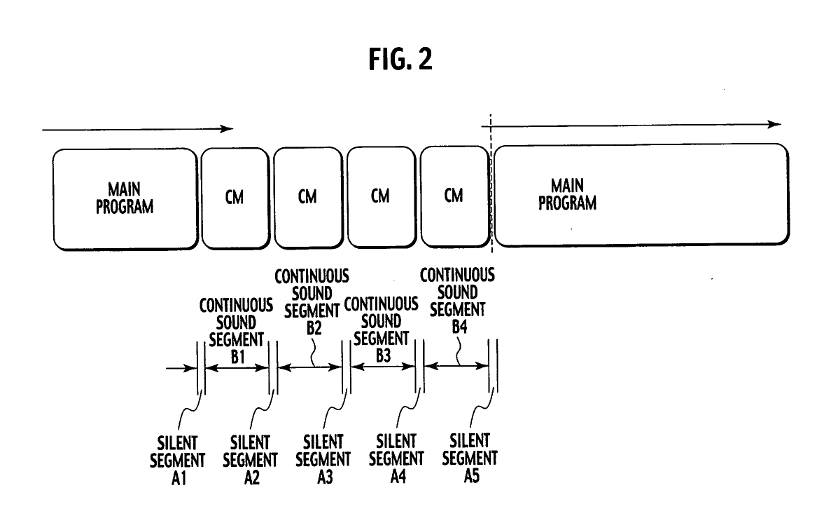

Next, a video recording process using the structure above is explained. FIG. 2 is a basic diagram showing a video content including CM with time flow and also demonstrates a situation where CMs are broadcast four times in the main program. In addition, by the following explanation of recording contents, A1, A2, A3, A4, and A5, as shown in the figure, are silent segments detected by a method as described below, and continuous sound segment B1 between silent segments A1 and A2, continuous sound segment B2 between silent segments A2 and A3, continuous sound segment B3 between silent segments A3 and A4, and continuous sound segment B4 between silent segments A4 and A5, are each CMs.

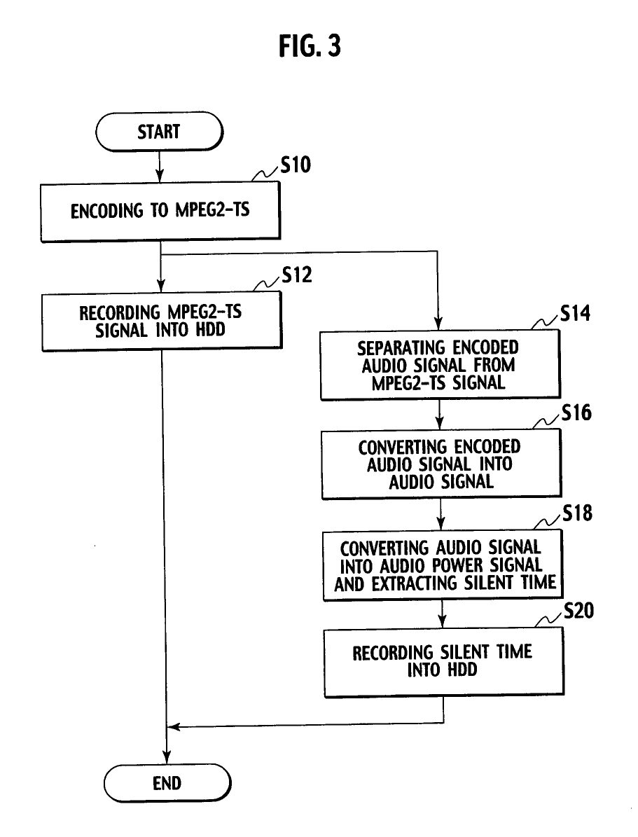

FIG. 3 is a basic flowchart showing a video recording process in a video playback apparatus. Tuner 11 receives an audio/video broadcasting signal and, detects to demodulate the signal to an encoded audio/video signal in the first step of this process (S10). The next step is transfer of the encoded audio/video signal through interface 15 and recording the signal into storage device 16 with the predetermined signal format (S12).

The other steps of the process comprise: sending the audio/video signal encoded in S10 to data separator 12 and separating into an encoded audio signal (S14), converting the encoded audio signal into an audio signal by audio decoder 13 (S16), detecting a corresponding time from each main program start and silent segments based on the audio signal in silent detector 14 (S18), and going through interface 15 and recording start time and end time of the silent segments into storage device 16 (S20). The step in S18 specifically converts the audio signal into an audio power signal and extracts a silent time. The steps from S10 to S20 are performed using the audio/video signal received in S10.

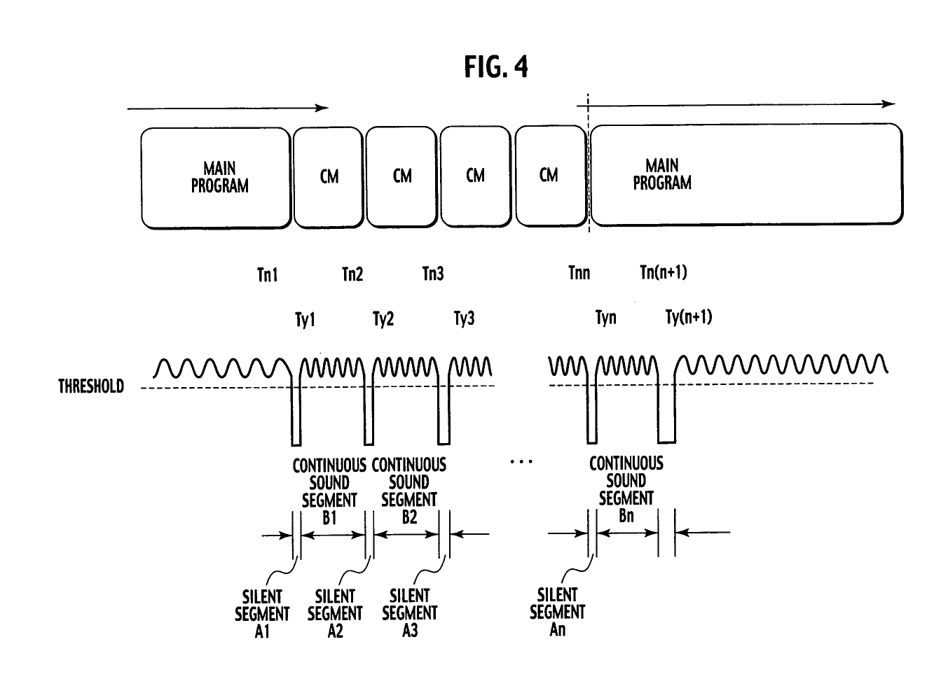

The procedure of detecting silent segments in the above S18 is explained with reference to FIG. 4. The silent detector 14 primarily performs this detecting silent segments procedure.

According to an embodiment, continuous sound is determined if the strength of the audio signal output is above a certain threshold, and silence is determined if the strength of the audio signal output is below a certain threshold. In this figure, segments A1, A2, A3, . . . , An are silent segments and segments B1, B2, . . . , Bn are continuous sound segments.

In general TV broadcasting, silent segments A before and after CM broadcasting are approximately one second, and a CM segment B between silent segments A is approximately fifteen seconds to ninety seconds of fixed time.

In S18 of FIG. 3, for silent segment information, a transition time from continuous sound to silence is recorded into storage device 16 as a start time of silent segment An. Also, a transition time from silence to continuous sound is recorded into storage device 16 as an end time of silent segment An.

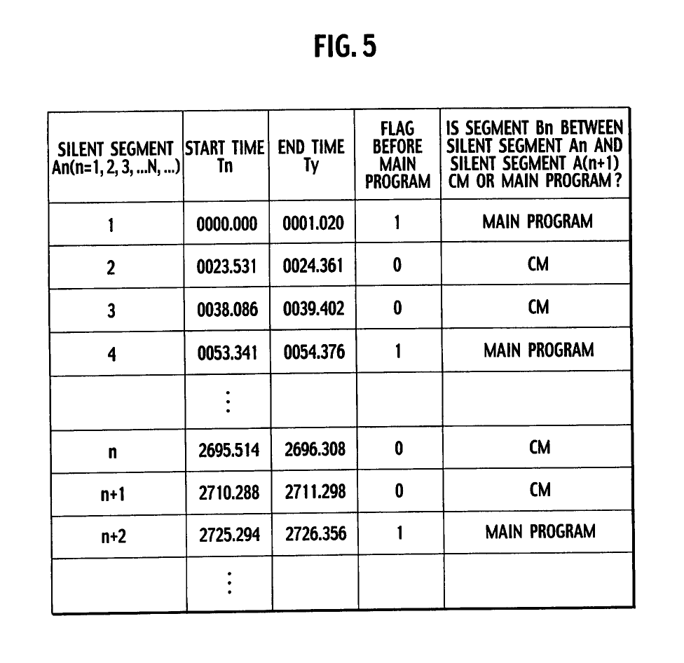

FIG. 5 shows an example recording pattern of silent segment information. A start time and an end time for each silent segment An are arranged and recorded. Further, in a CM detection process, determining a continuous sound segment Bn between a silent segment An and a subsequent silent segment A(n+1) as a CM or the main program is recorded with a result of CM detection in determination unit 23 along the silent segment information. This CM detection process is described below.

When a continuous sound segment Bn between the silent segment An and the subsequent silent segment A(n+1) and a continuous sound segment B (n+1) between the silent segment A(n+1) and a subsequent silent segment A(n+2) are changed from a CM to the main program, the silent segment A (n+1) between those continuous segments Bn and B (n+1) is marked with a flag “1”, which indicates that the main program starts from the continuous segment right after the silent segment A(n+1).

On the other side, when a continuous sound segment Bn between the silent segment An and the subsequent silent segment A(n+1) and a continuous sound segment B(n+1) between the silent segment A(n+1) and a subsequent silent segment A(n+2) are not changed from a CM to the main program, the silent segment A(n+1) between those continuous sound segments Bn and B(n+1) is marked with a flag “0”, which indicates that the main program does not start from the continuous sound segment right after the silent segment A(n+1).

As an example, FIG. 5 shows corresponding times of silent segment A1: 0.000 second for start time Tn(1) and 1.020 seconds for end time Ty(1), corresponding times of a silent segment A2: 23.531 seconds for start time Tn(2) and 24.361 seconds for end time Ty(2), corresponding times of silent segment A3: 38.086 seconds for start time Tn(3) and 39.402 seconds for end time Ty(3), and corresponding times of silent segment A4: 53.341 seconds for start time Tn(4) and 54.376 seconds for end time Ty(4). In addition, the continuous sound segment B1 between the silent segment A1 and the subsequent silent segment A2 is the main program, the continuous sound segment B2 between the silent segment A2 and the subsequent silent segment A3 is a CM, the continuous sound segment B3 between the silent segment A3 and the subsequent silent segment A4 is a CM, and the continuous sound segment B4 between the silent segment A4 and the subsequent silent segment A5 (excluded in the figure) is the main program. Also, a continuous sound segment B3 between the silent segment A3 and the subsequent silent segment A4 and a continuous sound segment B4 between the silent segment A4 and the subsequent silent segment A5 indicates a transition from a CM to the main program. As shown in FIG. 5, silent segment A1, which is found at the beginning of the main program (start time is 0 second) is marked with a flag “1” because of a transition from a CM.

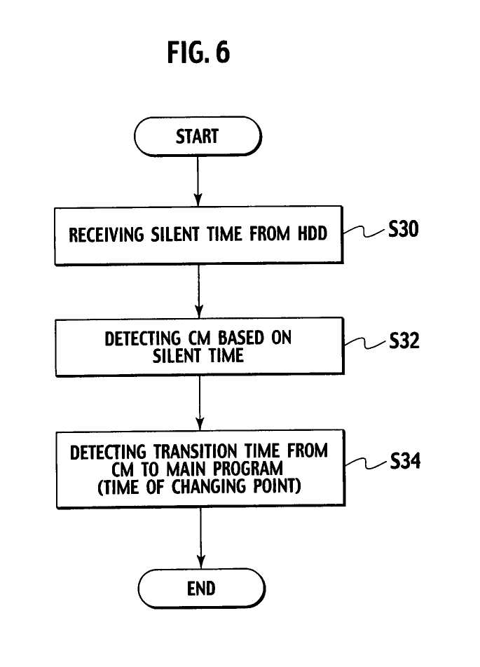

Next, the above mentioned CM detection process is explained. FIG. 6 through FIG. 8 show basic flowcharts that display a CM detection process with a video playback apparatus.

Determination unit 23 principally performs the CM detection process. Silent segments detected in silent detector 14 in the video recording process described above are used. In addition, this detection process starts at a selectable time after the recording process. For instance, playback controller 17 is executed prior to the contents when the latter is replayed.

First, step S30 in FIG. 6 obtains silent segment information from storage device 16 (S30). A continuous sound segment between a silent segment and a subsequent silent segment is determined as a CM or not in accordance with the obtained information (S32). This procedure is explained afterward.

On the basis of a result in S32, a silent segment is extracted and marked (S34), in which a continuous sound segment transmits from a CM to the main program. For instance, “1” is marked in a column of “Flag before main program” of a silent segment that changes to the main program in FIG. 5 and corresponds to a silent segment in which a continuous sound segment transmits from a CM to the main program. In another instance, “0” is marked to a column of “Flag before main program” of a silent segment that changes to the main program in FIG. 5 and corresponds to a silent segment in which a continuous sound segment does not transmit from a CM to the main program. The above procedure is performed on all of the silent segment information.

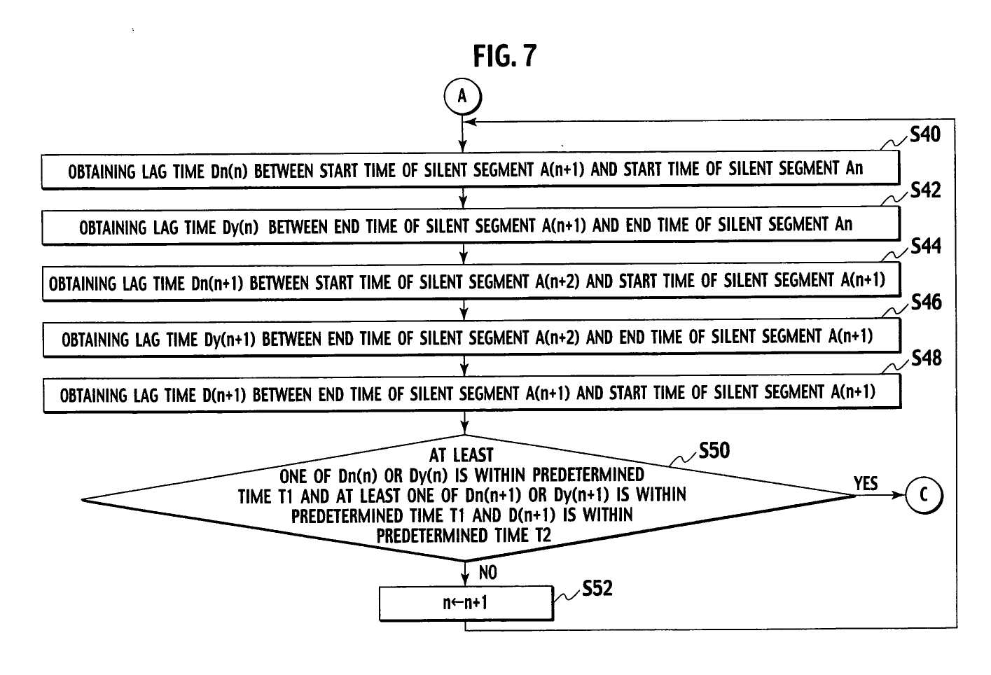

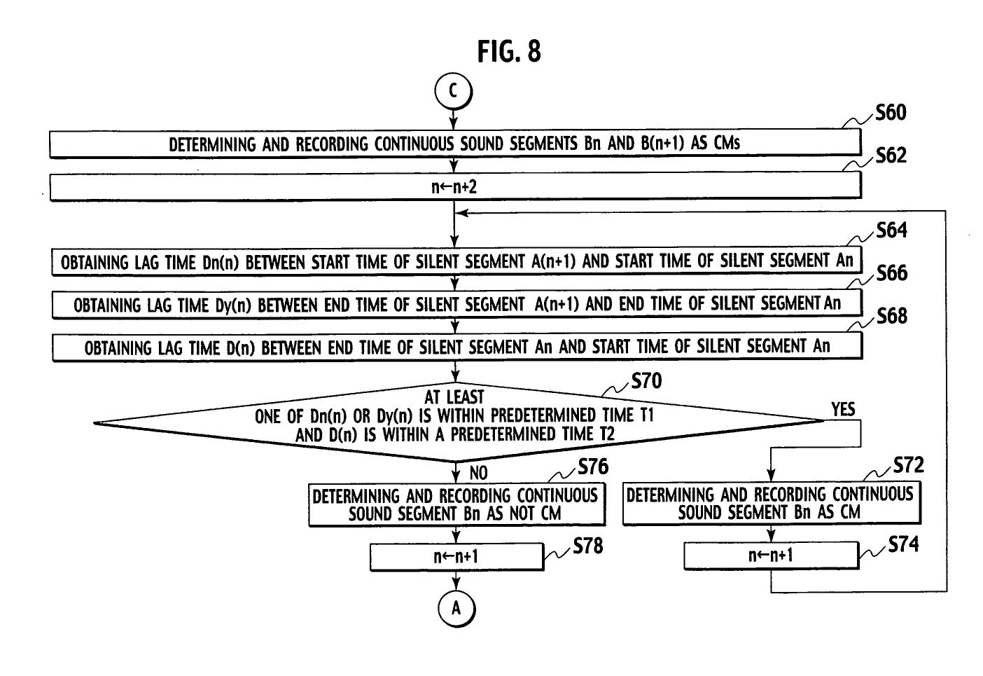

Secondly, step S32 in FIG. 6 is explained with flowcharts shown in FIG. 7 and FIG. 8. In step S40 in FIG. 7, an initial value of n=1 is defined, and the lag time Dn(n) between start time Tn(n+1) of (n+1)^{th} silent segment A(n+1) and a start time Tn(n) of n^{th} silent segment An is obtained (S40). Next, the lag time Dy(n) between an end time Ty(n+1) of (n+1)^{th} silent segment A(n+1) and an end time Ty(n) of n^{th} silent segment An is obtained (S42). Then, the lag time Dn (n+1) between a start time Tn(n+2) of (n+2)^{th} silent segment A(n+2) and a start time Tn(n+1) of (n+1)^{th} silent segment A(n+1) is obtained (S44), and the lag time Dy(n+1) between an end time Ty(n+2) of (n+2)^{th} silent segment A(n+2) and an end time Ty(n+1) of (n+1)^{th} silent segment A(n+1) is obtained (S46). Then, the lag time D(n+1) between an end time of (n+1)^{th} silent segment A(n+1) and a start time of (n+1)^{th} silent segment A(n+1) is obtained (S48).

Using results Dn(n), Dy(n), Dn(n+1), Dy(n+1), and D(n+1) of steps from S40 to S48, step S50 identifies whether the following condition: “At least one of Dn(n) or Dy(n) is within a first predetermined time T1, and at least one of Dn(n+1) or Dy(n+1) is within a first predetermined time T1, and D(n+1) is within a second predetermined time T2” is satisfied (s50). When the condition is satisfied, as a result in S50, S50 proceeds to S60. If the condition is not satisfied, the corresponding silent segment information is updated with the change in value from n to n+1 (S52), and the process shifts back to S40.

In step S60 shown in FIG. 8, continuous sound segments Bn and B(n+1) are both determined as CMs. As a result of the CM determination of the continuous sound segments Bn and B(n+1), “CM” is marked down to corresponding columns of “Is segment Bn between An and A (n+1) CM or Main Program?” and “Is segment Bn between A(n+1) and A(n+2) CM or Main Program?” in FIG. 5 (S60). Then, the corresponding silent segment information is updated with a change in value from n to n+2 (S62).

Next, the lag time Dn(n) between a start time Tn(n+1) of (n+1)^{th} silent segment A(n+1) and a start time Tn(n) of n^{th} silent segment An is obtained (S64). Then, the lag time Dy(n) between an end time Ty(n+1) of (n+1)^{th} silent segment A(n+1) and an end time Ty(n) of n^{th} silent segment An is obtained (S66). And then, the lag time Dn(n) between an end time of (n)^{th} silent segment An and a start time of (n)^{th} silent segment An is obtained (S68).

Using results Dn(n), Dy(n), and D(n) of steps from S64 to S68, step S70 identifies whether the following condition: “At least one of Dn(n) or Dy(n) is within a first predetermined time T1 and D(n) is within a second predetermined time T2” is satisfied (S70). When the condition is satisfied, as a result in S70, S70 proceeds to S72. If the condition is not satisfied, S70 proceeds to S76.

When the condition is satisfied, continuous sound segment Bn is determined as a CM, and “CM” is marked in the corresponding column of “Is segment Bn between An and A(n+1) CM or Main Program?” in FIG. 5 (S72). Then, corresponding silent segment information is updated with a change in value from n to n+1 (S74), and the process shifts back to S64. This process is performed repeatedly on all the silent segment information.

If the condition is not satisfied, then the continuous sound segment Bn is not deemed a CM, more specifically, it is a main program. At this time, “Main Program” is marked in a corresponding column of “Is segment Bn between An and A(n+1) CM or main Program?” in FIG. 5 (S76). Then the corresponding silent segment information is updated with a change in value from n to n+1 (S78), and the process shifts back to S40. This process is repeatedly performed on all the silent segment information.

A first predetermined time T1 used in S50 and S70 is equal to current CM times, which are fifteen seconds, thirty seconds, sixty seconds, and ninety seconds, etc . . . , and a second predetermined time T2 is approximately one second.

Next, a skip action in this embodiment is described below. When a user wants to skip a CM and seek a playback to the main program, the user instructs this skip action. A skip action usually has two directions which are forward direction and reverse direction in the direction of playback.

Usually, when CM is replayed after the main program, a user instructs a skip action in forward direction to replay a main program after this CM.

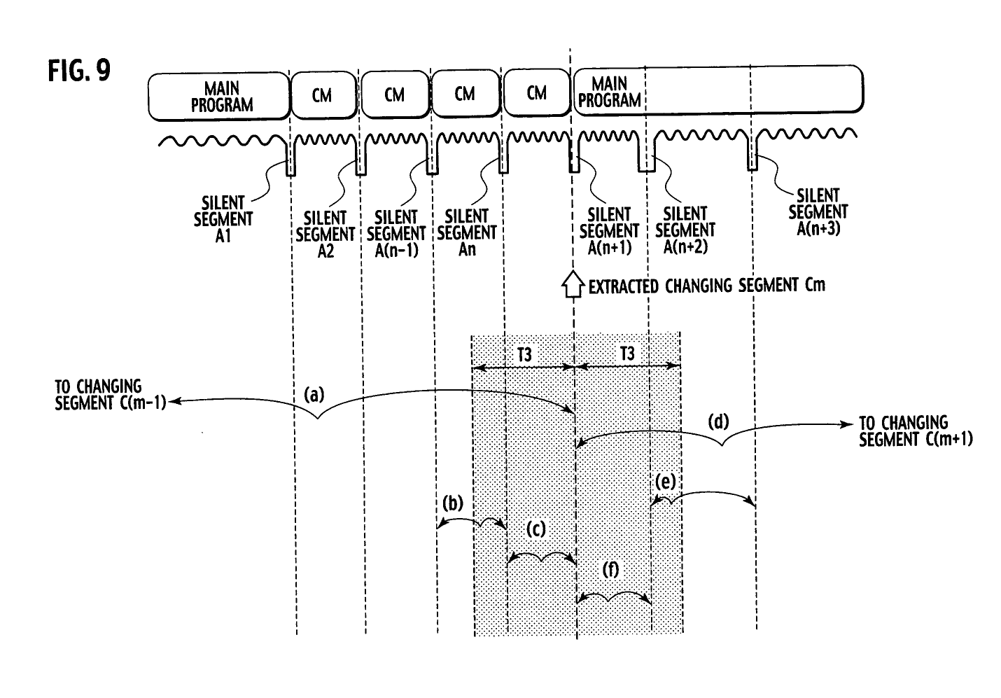

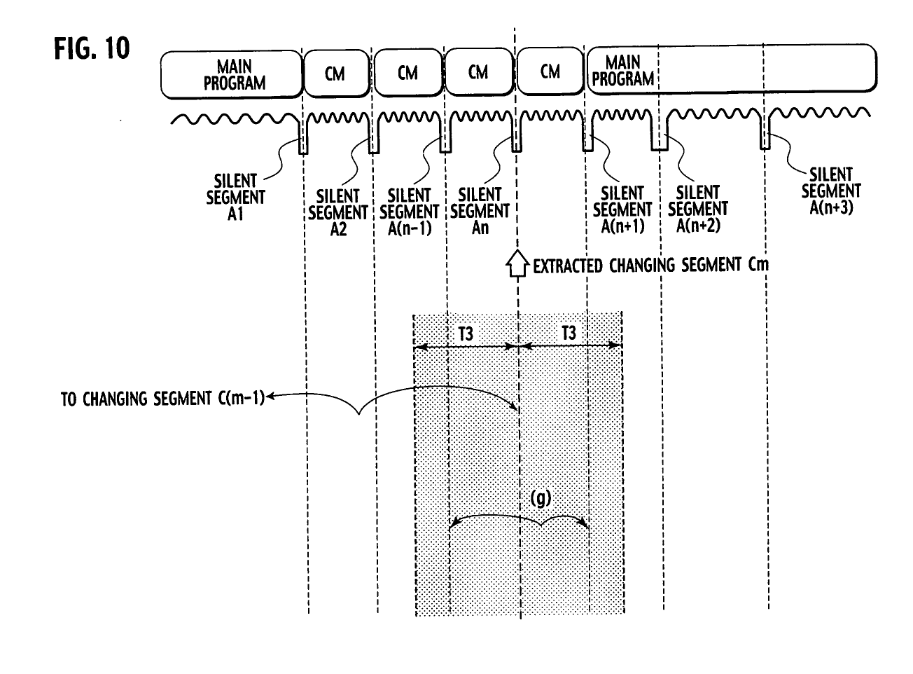

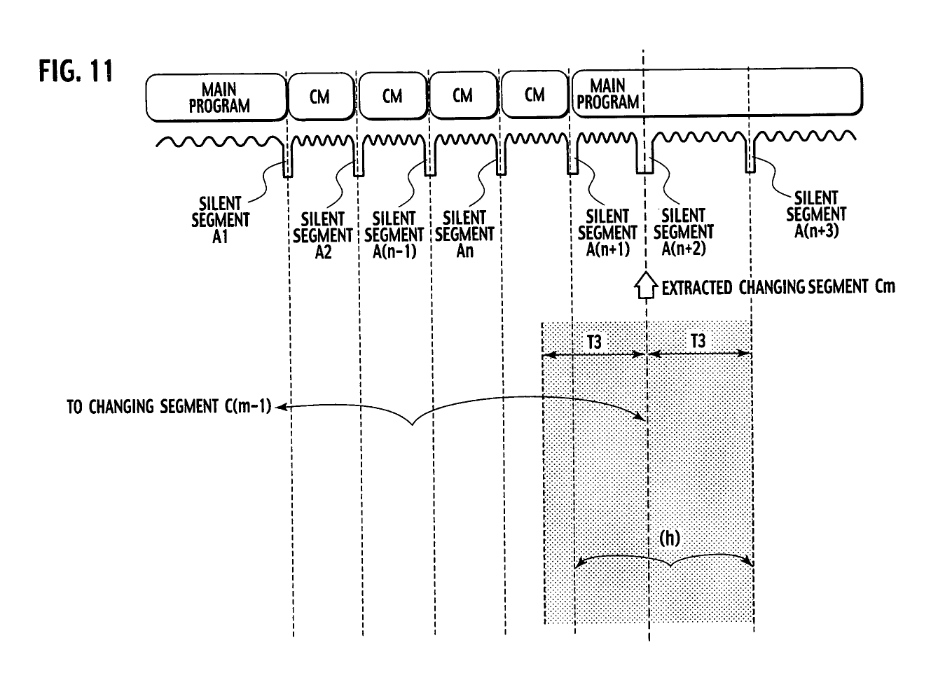

FIGS. 9 to 11 are basic diagrams that explain a skip action in an embodiment. Silent segments A1, A2, A3, . . . , An, A (n+1), A (n+2), . . . are the silent segments which are detected in the order of a time axis. Changing segment Cm is a silent segment between a preceding continuous sound segment that is CM and a subsequent silent segment that is the main program. In the embodiment of FIG. 9, the changing segment Cm is A(n+1). In addition, as seen in the embodiment of FIG. 10, as a result of the CM detection, the changing segment Cm is determined as An. Embodiment of FIG. 11 shows that the changing segment Cm is determined as A(n+2). In a position (a) of FIG. 9, when a skip action is instructed in a segment between silent segments A1 and A2, and when the lag time between the present position and the start time or the end time of the nearest changing segment Cm is not within a third predetermined time T3, a skip to the next nearest changing segment Cm in forward direction or to the next nearest change segment C(m−1) in reverse direction are shown.

A position (b) of FIG. 9 shows that, when a skip action is instructed in a segment between the silent segment A(n−1) and the silent segment An and when the lag time between the present position and the start time or the end time of the nearest changing segment Cm is within a third predetermined time T3, a skip is performed to the next nearest silent segment An in forward direction or to the next nearest silent segment A(n−1) in reverse direction.

A position (c) of FIG. 9 shows that, when a skip action is instructed in a segment between the silent segment An and the silent segment A(n+1) and when the lag time between the present position and the start time or the end time of the nearest changing segment Cm is within a third predetermined time T3, a skip is performed to the next nearest silent segment A(n+1) in forward direction or to next nearest silent segment An in reverse direction.

A position (d) of FIG. 9 shows that, when a skip action is instructed in a segment between the silent segment A (n+2) and the silent segment A(n+3), and when the lag time between the present position and the start time or the end time of the nearest changing segment Cm is not within a third predetermined time T3, a skip is performed to the next nearest changing segment C (m+1) in forward direction or to the next nearest changing segment Cm in reverse direction.

A position (e) of FIG. 9 shows that, when a skip action is instructed in a segment between the silent segment A (n+2) and the silent segment A(n+3) and when the lag time between the present position and the start time or the end time of the nearest changing segment Cm is within a third predetermined time T3, a skip is performed to the next nearest silent segment A (n+3) in forward direction or to the next nearest silent segment A(n+2) in reverse direction.

A position (f) of FIG. 9 shows that, when a skip action is instructed in a segment between silent segment A (n+1) and silent segment A(n+2) and when the lag time between the present position and the start time or the end time of the nearest changing segment Cm is within a third predetermined time T3, a skip is performed to the next nearest silent segment A (n+2) in forward direction or to the next nearest silent segment A(n+1) in reverse direction.

A position (g) of FIG. 10 shows that silent segment An is determined as a boundary of a CM and a main program. In a CM skip, when a skip action is instructed in a condition of starting a playback from the changing segment Cm (silent segment An) and when the lag time between this present playback position and the start time or the end time of the nearest changing segment Cm is within a third predetermined time T3, a skip is performed to the next nearest silent segment A(n+1) in forward direction or to the next nearest silent segment A(n−1) from the changing segment Cm (silent segment An) in which playback is started in reverse direction.

A position (h) of FIG. 11 shows that silent segment A(n+2) is determined as a boundary of CM and a main program. In a CM skip, when a skip action is instructed in a condition of starting a playback from the changing segment Cm (silent segment A(n+2)) and when the lag time between this present playback position and the start time or the end time of the nearest changing segment Cm is within a third predetermined time T3, a skip is performed to the next nearest silent segment A(n+3) in forward direction or to next nearest silent segment A(n+1) from the changing segment Cm (Silent Segment A (n+2)) in which playback is started in reverse direction.

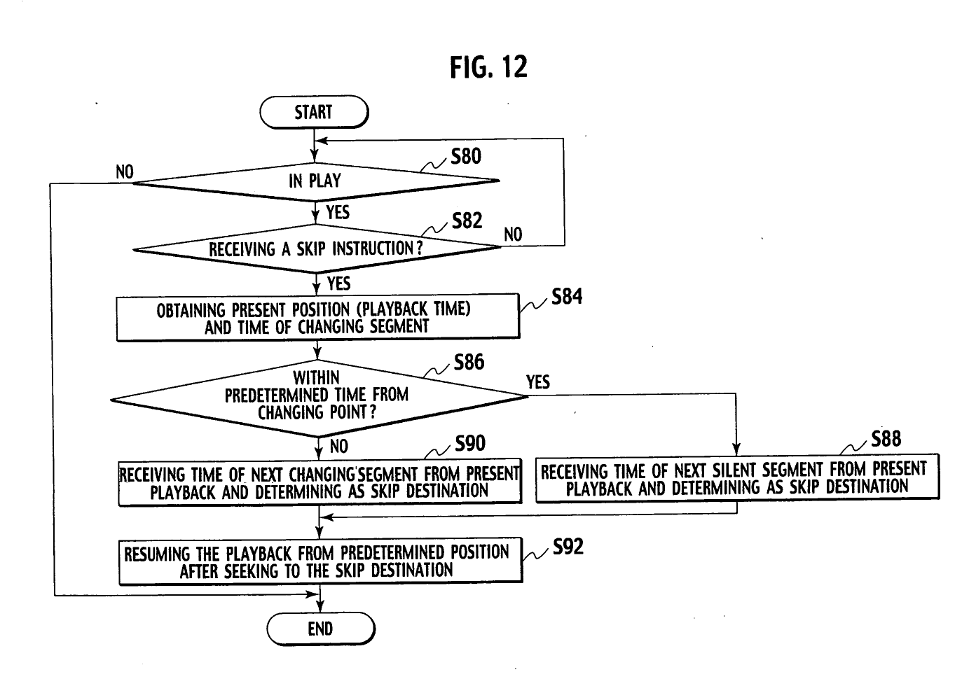

FIG. 12 is a basic flowchart showing a skip action in this embodiment. For clarification of a procedure only the forward direction is explained, however, a similar procedure can be applied to the reverse direction by inverting the time axis.

In S80, system controller 18 determines whether contents are in play (S80). When it is being replayed, a process proceeds to S82. Otherwise, a process is finished.

Next, system controller 18 determines whether or not a skip instruction is received (S82). When a skip instruction is not received, a process proceeds to S80. When there is a skip instruction received, a process proceeds to S84. In S84, playback controller 17 obtains the present playback time, which is a relative elapsed time from the beginning of a content playback.

And, playback controller 17 refers to silent segment information from storage device 16, and obtains a silent segment which is the nearest changing segment to the present playback time (S84). Subsequently, the lag time between the present playback time and the changing segment obtained in S84 is obtained, and a determination is made whether this is within a third predetermined time T3 (S86). A third predetermined time T3 utilized for determination in S86 is selectable, and is 20 seconds as exemplified in this embodiment. In S86, when the lag time between the present playback time and the changing segment is within a third predetermined time T3, the nearest silent segment from the present playback time is obtained from the silent segment information that is recorded into storage device 16 and is determined as a skip destination (S88).

On the contrary, when the lag time between the present playback time and the changing segment is not within a third predetermined time T3, the silent segment that is the nearest changing segment from the present playback time is obtained from the silent segment information that is recorded to storage device 16 and is determined as a skip destination (S90).

The start time or the end time of the silent segment may be utilized for determining the address of a skip destination in S88 and S90. Based on the above, the time may be approximately one second before. And, a present playback time seeks to an address of a skip destination that is obtained in S88 and S90, and a playback is resumed (S92), then a skip action is completed. In this case, the playback is resumed after relocation to one second before the skip destination.

According to the above, in determinations of S50 and S70, a silent segment in contents can be accurately detected as a CM by multiple conditions.

Particularly, by utilizing a start time or an end time of a silent segment, even several seconds of the silent segment, which is possibly occurred in a boundary of the main program and a CM, can be detected. And, a continuous sound segment between the previous silent segment and the next silent segment in time axis, can be selected as a CM (namely a main program). As a result, the previous continuous sound segment and the next continuous sound segment in time axis can be determined as a transition to a main program from CM or not.

Furthermore, in this playback of a CM skip, as a result of the foregoing determination, namely, a transition from the above CM to the main program can be visibly recognized, by utilizing a silent segment changing from a CM to the main program, in order to resume the playback from the continuous sound segment, which is several seconds before this silent segment.

In this way, the beginning part of the main program in the contents (changing point from a CM to the main program) of a silent segment can be accurately detected. By setting the playback position to this detected silent segment, it is possible to skip a CM and replay the main program subsequently. Thus, a CM skip can be appropriately performed.

In this embodiment, when a skip is instructed from a position where a CM is changing to the main program to a position where time length is within the predetermined time, a playback position is set at the nearest silent segment to the present playback position in a playback direction. Therefore, a user can ensure a skip action at a small unit.

Even more particularly, a user is able to continue the playback of a main program by one skip operation, and user's convenience can be improved.

In addition, by recording information about the detected silent segment into the storage device, this silent segment information is obtained by certain timing, and can be determined whether or not the silent segment is detected within the predetermined time length.

Further, a start time and an end time are used as information regarding silent segments in the above described embodiment; however, its median time may also be used.

In addition, the predetermined time T1 in S50 and S70 is selected from a time value, such as thirty seconds, sixty seconds, ninety seconds, etc., in the above described embodiment. However, all such time values (thirty seconds, sixty seconds, and ninety seconds, etc . . . ) also may be selected at the same time and be used in the determination processes.

In addition, information regarding silent segments is recorded into storage device (s) to detect CMs in the above described embodiment; however, without recording into the storage device(s), CM detection may also simultaneously be performed with processing playback.

Also, a third predetermined time T3 utilized for determination in S86 in the above embodiment is twenty seconds as an example. But, for example, the time may be a standard value for a CM such as fifteen seconds, thirty seconds, and sixty seconds etc., plus a (a=around 5 seconds).

Detailed description of embodiments relating to the invention have been explained, but the invention and significant terms of each constitute matter are not limited to what is described in this detailed description.

What is claimed is:

1. A video playback apparatus, comprising:
a silent detector configured to detect a silent segment based on output of an audio signal of contents;
a determination unit configured to determine a segment, in which the time length of each silent segment is essentially a multiplication of the predetermined time, as a first content segment regarding continuous plural silent segments that are detected in the silent detector, configured to determine a segment in which the time length of each silent segment is not essentially a multiplication of the predetermined time, as a second content segment, and configured to extract a silent segment between the first content segment and the second content segment as a changing segment; and
a playback controller configured to set a playback position of contents to the position before a predetermined time from the changing segment when a first action instruction is received.

2. The video playback apparatus as claimed in claim 1, wherein the silent detector detects a start position of the silent segment.

3. The video playback apparatus as claimed in claim 2, wherein the determination unit determines a segment in which the start time of each silent segment is essentially a multiplication of the predetermined time as a first content segment regarding continuous plural silent segments that are detected in the silent detector, and a segment in which the start time of each silent segment is not essentially a multiplications of the predetermined time as a second content segment, and extracts a silent segment in between the first content segment and the second content segment as a changing segment.

4. The video playback apparatus as claimed in claim 1, wherein the changing segment is a silent segment after a first content segment.

5. The video playback apparatus as claimed in claim 1, wherein the silent detector detects the end position of the above silent segment.

6. The video playback apparatus as claimed in claim 5, wherein the determination unit determines a segment in which the end time of each silent segment is essentially a multiplication of the predetermined time as a first content segment regarding continuous plural silent segments that are detected in the silent detector, and a segment in which the end time of each silent segment is not essentially a multiplication of a predetermined time as a second content segment, and extracts a silent segment in between the first content segment and the second content segment as a changing segment.

7. The video playback apparatus as claimed in claim 1, wherein the silent detector detects the start position and the end position of the above silent segment, and determines the median position of those.

8. The video playback apparatus as claimed in claim 5, wherein the determination unit determines a segment in which the median time of each silent segment is essentially a multiplication of the predetermined time as a first content segment regarding continuous plural silent segments that are detected in the silent detector, and a segment in which the median time of each silent segment is not essentially a multiplications of the predetermined time as a second content segment, and extracts a silent segment between the above first content segment and the second content segment as a changing segment.

9. The video playback apparatus as claimed in claim 6, wherein the playback controller sets a playback position of contents to before the predetermined time from a median time of the above changing segment when a first action instruction is received.

10. The video playback apparatus as claimed in claim 1, wherein the playback controller obtains the present playback time and the time of the above changing segment, and determines whether the present playback time is within the predetermined time of the above changing segment time; wherein
when the present playback time is outside the predetermined time of the above changing segment time, then the playback time is set to a position prior to the predetermined time from the start position of the above changing segment.

11. The video playback apparatus as claimed in claim 2, wherein when the present playback time is within the predetermined time of the above changing segment time, playback time is set to a position prior to the predetermined time from the start position of the next silent segment.

12. The video playback apparatus of claim 1, wherein when a second action instruction is received following the above action instruction in the direction of the said second action instruction, the playback position is set as a standard playback position to a position prior to the predetermined time from the nearest start position of a silent segment from the present playback position.

13. The video playback apparatus of claim 1, wherein when instructions of a skip action in a forward direction and reverse direction of a playback are received following the action instruction, the playback position is set as a standard playback position to a position prior to the predetermined time from the start position of the silent segment, which is two segments before present playback position.

14. The video playback apparatus of claim 1, wherein when time length of the silent segment is detected as fifteen seconds, thirty seconds, sixty seconds, or ninety seconds, a continuous sound segment between these silent segments is determined as the first content segment.
